(19) United States
(12) Patent Application Publication
(10) Pub. No.: US 2005/0105965 A1
(43) Pub. Date: May 19, 2005

(54) Coupling device for an artificial model

(76) Inventor: Jung-Chang Chiang, Taipei (TW)

Correspondence Address: Hsu & Associates, P. O. Box 72, Nankang, Taipei, 115, TW

(21) Appl. No.: 10/714,385

(22) Filed: Nov. 13, 2003

(51) Int. Cl. F16B 1/00

(52) U.S. Cl. 403/344

(57) ABSTRACT

A coupling device for an artificial model includes a male joining part and a female joining part, which is joined to the male joining part tightly. The male joining part has the front positioning plate thereof providing a central circular protrusion, the insertion member thereof is composed of an insert head, a pin, an adjustment bolt, an elastic body and a covering cap with the insert head having a conical shape and an elongated flat part at the bottom thereof with the pin being inserted into the insert head along a radial direction of the insert head and passing through an axis of the insert head to form a shape of cross, and a hollow center thereof has a shape corresponding to the elongated flat part of the insert head such that the elongated flat part of the insert head can fit with the hollow center after being inserted into the hollow center with the adjustment bolt passing through the cap and the elastic body before engaging with the bottom of insert head. The female joining part has the front positioning plate with a center thereof providing a hollow part with a plurality of equidistant radial grooves and two opposite ones of the radial grooves are pierced with the pin; and a radial recess is disposed between two neighboring ones of the radial grooves respectively. Hence, the male joining member and the female joining member can be joined to each other tightly and be inserted into each other for achieving a purpose of positioning.

### BACKGROUND OF THE INVENTION

1. Field of the Invention

The present invention relates to a coupling device for an artificial model, and, particularly, to a coupling device, which has a male connecting member and a female connecting member being attached to two opposite connecting surfaces of the neck and the hip of the artificial model respectively to secure the two connecting surfaces being joined to each other tightly by way of two sets of elastic bodies engaging with each other.

2. Description of Related Art

Referring to FIG. 10, the conventional artificial model 30 at the hip part 31 and the thigh part 32 thereof provides a stem device 33 at two opposite connecting surfaces respectively. In order to put on pants, it is necessary to detach the thigh part 32 from the hip part 30 in advance and the pants can be put on the thigh part 32 before the stem device 33 on the thigh part 32 can be inserted into the hip part 30. However, the stem device 33 is too much simply constructed so that it is not possible to obtain a firm joint between the hip part 31 and the thigh part due to a clearance 34 being generated. Moreover, it is easy for the thigh part to oscillate and result in the artificial model falling down or askew exhibited clothes due to an unbalancing center of gravity of the artificial model. Furthermore, once the stem device 33 is out of order, it is hard to be fixed unless the whole set of the artificial model is delivered to the repair shop and it becomes extremely inconvenient and less economical.

Referring to FIGS. 11A, 11B and 12, a conventional pin 442 and a locating disk 42 are illustrated. It can be seen that the locating disk 42 has a hollow center 422 for being inserted with the insert head 441 and two opposite elongated grooves 423 and two opposite recess 424 are disposed surrounding the hollow center 422 with the grooves 423 being perpendicular to the recesses. The pin 442 can pass through the hollow center 423 and be rotated 90° to engage with the recesses 424. The arrangement of pin 442 with the locating disk 42 are mostly used at the thigh separation part 35 of the artificial model (shown in FIG. 12) has the following disadvantages:
1. The thigh separation part 35 is improperly disposed so that it is unpleasing to the eye while shorts or swimming suit is put on;
2. Only a pair of elongated grooves 423 is provided so that it is not easy to locate the pin 442 due to a long rotational path being turned.
3. It is easy for the pin 442 and the locating disk 42 to become out of order due to the pin 442 being turned all the time so that friction between the pin 442 and the locating disk 42 results in severe wearing out.
4. It is possible for the pin to be turned into the hollow center with one direction only so that it is easy for the thigh part 36 being inversely mounted (shown in FIG. 11).
5. In case of the artificial model 30 is in a state of a posture of sitting with two thighs being cross to each other as shown in FIG. 13, the pin 442 is incapable of being turned into the recesses 424 if the locating disk 42 provides improper angle and it results in the thigh 37 being unable to be rotated in place.

Further, another conventional locating disk, which is similar to the locating disk 42, provides the elongated grooves 423 only so that it is not possible to perform the job of locating because of no recesses 424.

### SUMMARY OF THE INVENTION

A main object of the present invention is to provide a coupling device for an artificial model for connecting surfaces being joined tightly after two half parts of the coupling device being inserted into each other.

Another object of the present invention is to provide a coupling device for an artificial model with the male and the female connecting members and locating threaded holes being standardized fabrication so that both legs of the artificial model can be interchanged and different artificial model also can be interchanged so as to meet economical principle.

A further object of the present invention is to provide a coupling device for an artificial model with parts thereof being fastened by way of bolts so that it is convenient for replacing damage parts quickly without the need of being fixed in shop.

A further object of the present invention is to provide a coupling device for an artificial model with two sets of elastic bodies to allow the male connecting member, the female connecting member and the pin generating a defense compressing space during rotating such that it is possible to obtain a coupling device with low wear, little resistance and low chance of damage and it is more easy to be operated and assembled.

### BRIEF DESCRIPTION OF THE DRAWINGS

The other objects and features of the present invention can be more fully understood by reference to the following description of preferred embodiments in company with the drawing, in which:

FIG. 1 is an exploded perspective view of a male joining member of a coupling device for an artificial model according to the present invention;

FIG. 2 is an exploded sectional view of the male joining member shown in FIG. 1;

FIG. 3 is an assembled perspective view of the male joining member shown in FIG. 1;

FIG. 4 is an exploded perspective view of a female joining member of the coupling device for an artificial model according to the present invention;

FIG. 5 is an exploded sectional view of the female joining member shown in FIG. 4;

FIG. 6 is an assembled perspective view of the female joining member shown in FIG. 4;

FIGS. 7A and 7B are plan views illustrating movements of positioning done by an insertion member in the coupling device of the present invention;

FIG. 8 is a sectional view of the coupling device for an artificial model according to the present invention;

FIG. 9A is a sectional view illustrating the coupling device being embodied in the artificial model with the left side thereof being in a state of opening;

FIG. 9B is a sectional view illustrating the coupling device being embodied in the artificial model with the right side thereof being in a state of opening;

FIG. 10 is a plan view illustrating a conventional hip joint of the artificial model;

FIGS. 11A and 11B are plan views illustrating movements of positioning done by a conventional pin;

FIG. 12 is a plan view illustrating another conventional hip joint of the artificial model; and

FIG. 13 is a plan view illustrating the seat posture of the artificial model;

### DETAILED DESCRIPTION OF THE PREFERRED EMBODIMENTS

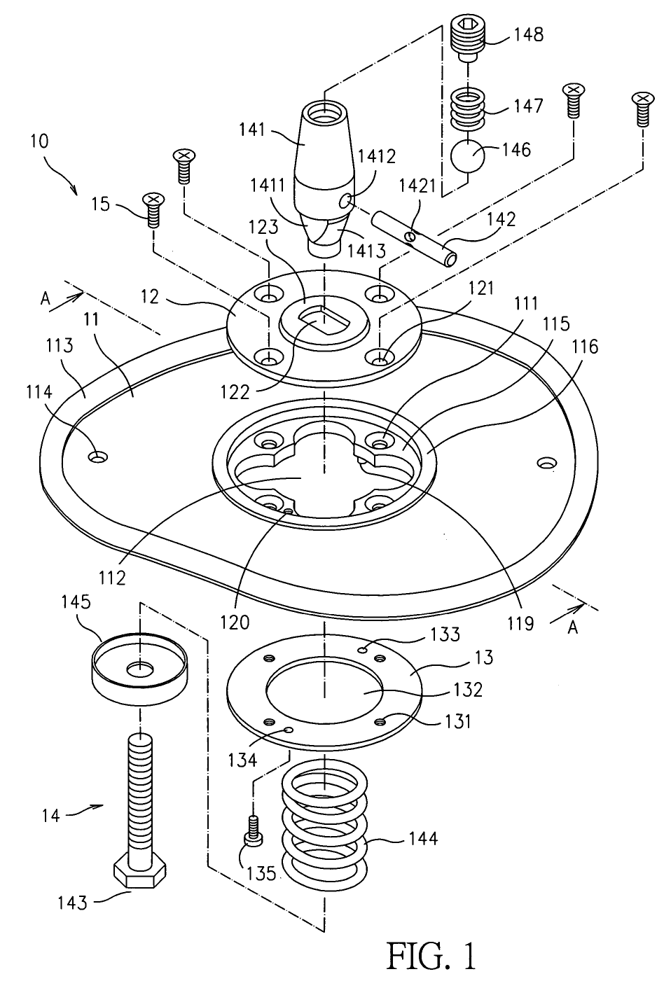

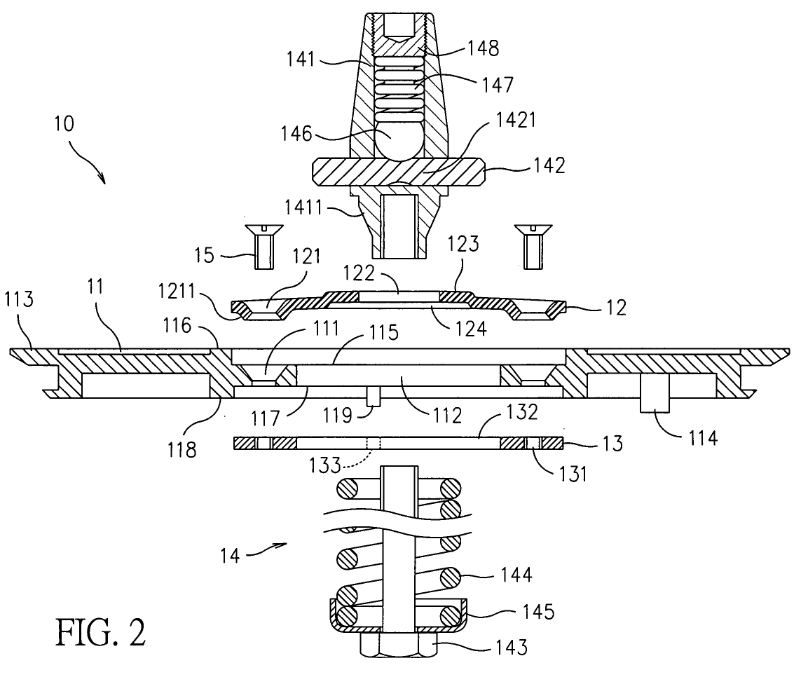

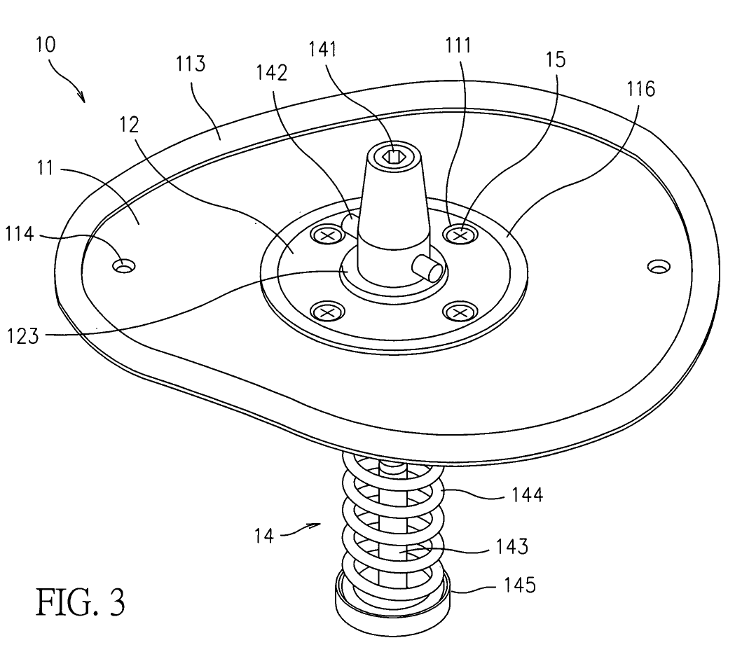

Referring to FIGS. 1 to 3, a coupling device for an artificial model according to the present invention provides a male joining part 10, which includes a base disk 11, a front positioning plate 12, a rear positioning lock plate 13 and an insertion member 14.

The base disk 11 at the periphery thereof is provided with an upright rim 113 and at the center thereof is provided with a hollow central part 112. Two opposite threaded holes 114 with respect to the hollow central part 112 and disposed near the upright rim 113 pierce the base disk 11 and the two threaded holes allow the base disk 11 to be located at one of the connection interfaces on the separated hips. The base disk 11 at two facial sides thereof has a recess 115, 117 respectively and the recesses 115, 117 at the circumferences thereof have a flange 116, 118 respectively. A partition between the recesses 115, 117 surrounds the hollow central part 113 and is provided with four threaded holes 111 with a countersink top respectively.

The front positioning plate 12 is circular and disposed in the recess 115 of the base disk 11 with a central protrusion part 123 such that the bottom of the central protrusion part 123 is formed a recessing 124. The protrusion part 123 further has an elongated hollow part 122. In addition, the front positioning plate 12 is provided with threaded holes 121 corresponding to the threaded holes 111 of the base disk 11 and each of the threaded holes 121 has a conical lower end 1211 extending outward from the bottom thereof.

The rear positioning lock plate 13 is provided with an annular shape and disposed in the recess 117 of the base disk 11 with threaded holes 131 corresponding to the threaded holes 111 of the base disk 11 and the threaded holes 121 of the front positioning plate 12. Further, the rear positioning lock plate 13 has an aperture 133 and a threaded hole 134 corresponding to a post 119 and a threaded hole 120 disposed at the partition between the recesses 115, 117 for locating the rear positioning lock plate 13. It can be seen in the figures that the post 119 extends down from the recess 117 to pierce the aperture 133 and a bolt 135 is utilized to engage with the threaded holes 134, 120 respectively so as to secure the rear positioning lock plate 13 being located in the recess 117 as protect for the base disk 11. It is noted that no specific spots are required for arranging the post 119 and the threaded hole 120 so that it can be accepted in case of the post 119 and the threaded hole 120 being disposed at any places under a condition of the rear positioning lock plate 13 being corresponding to the base disk 11.

The insertion member 14 is composed of an insert head 141, a pin 142, an adjustable bolt 143, an elastic body 147 and a cap 145 for the elastic body 147. The insert head 141 is hollow with two conic end parts and inner screw threads. A ball 146 and the elastic body 147 such as a spring or a spring plate are placed therein and fastened with a setscrew 148. The insertion member 14 at the lower end part thereof is provided with a flat part 1411 to loosely fit with the elongated hollow part 122 of the front positioning plate 12. The pin 142 at the middle section thereof has a recess 1421 and inserted into a fitting hole 1412, which is perpendicular to the axial direction of the insert head 141 and passes across the axis of the insert head 141, such that the ball 146 can be located at the recess 1421 because of the elastic force of the elastic body 147 and a tight fit between the ball 146 and the elastic body 147 constitutes the insertion member 14 at the upper and the lower parts thereof having elastic positioning structure.

Thus, the front positioning plate 12 and the rear positioning lock plate 13 can be secured to the base disk 11 by way of bolts 15 passing through and being fastened to the threaded holes 121, 111, 131 after the front positioning plate 12 being placed in the recess 115 and the rear positioning lock plate 13 being placed in the recess 117. Because the four threaded holes 121 are equally spaced from each other, the front positioning plate 12 and the rear positioning lock plate 13 have two orthogonal adjustment directions respectively for different postures of the artificial model at the legs thereof. Next, the insert head 141 at the elongated flat part 1411 thereof is arranged to pass through the elongated hollow part 122 of the front positioning plate 12 from the top of the base disk 11 to constitute a state of being immobilized. Then, the adjustment bolt 143 is arranged to pass through the cap 145 and the elastic body 144 sequentially to engage with the lower end of the insert head 141 disposed under the base disk 11 with the elastic body 144 pressing against the recess 124 at the lower side of the front positioning plate 12. In this way, the male joining member 10 can be set up completely. Due to the threaded holes 111, 121 being provided with a countersink respectively, a flexible adjustment space is available between the front positioning plate 12 and the base disk 11 to allow the bolts 15 being capable of fastening the front positioning plate 12 and the base disk 11 firmly. Further, the recess 124 of the front positioning plate 12 provides a function of locating the elastic body 144 to prevent the elastic body 144 from slip and the central protrusion part 123 on the front positioning plate 12 can limit the elastic body 144 from moving to enhance effect of the elastic body 144 being located. Once the adjustment bolt 143 of the insertion member 14 is engaged to the insert head 141, a force resulting from the elastic body 144 being biased between the recess 124 of the front positioning plate 12 and the cap 145 can pull down the insert head 141. The function of the force will be explained in detail underneath.

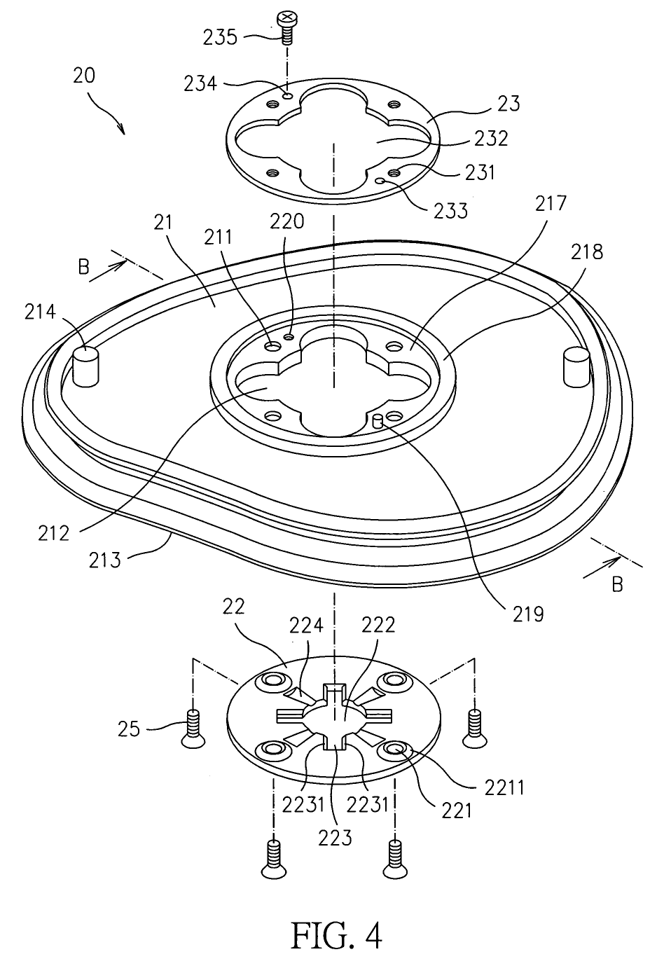

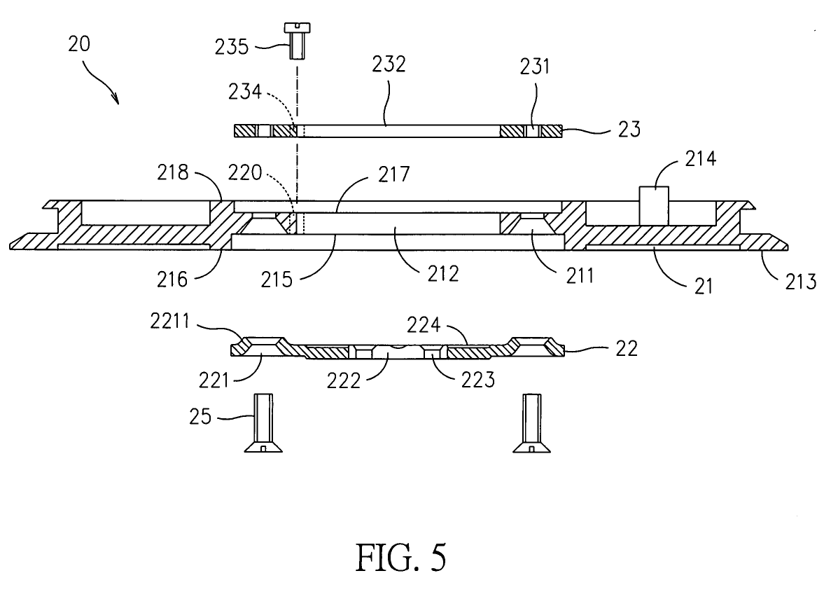

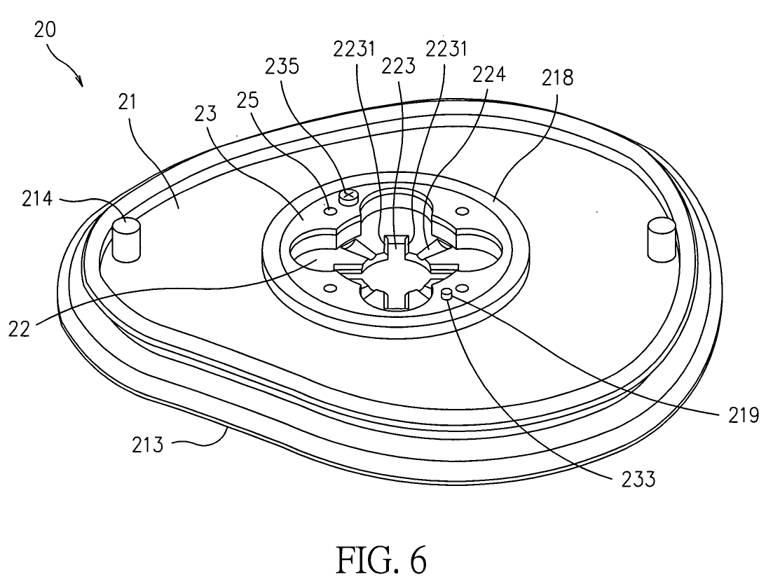

Referring to FIGS. 4 to 6, the coupling device for an artificial model according to the present invention further provides a female joining part 20 and the female joining member 20 includes a base disk 21, a front positing plate 22 and a rear positioning lock plate 23.

The base disk 21 at the periphery thereof is provided with an upright rim 213 and at the center thereof is provided with a hollow central part 212. Two opposite threaded holes 214 with respect to the hollow central part 212 and disposed near the upright rim 213 pierce the base disk 11 and the two threaded holes allow the base disk 21 to be located at another one of the connection interfaces on the separated hips. The base disk 21 at two facial sides thereof has a recess 215, 217 respectively and the recesses 215, 217 at the circumferences thereof have a flange 216, 218 respectively. A partition between the recesses 215, 217 surrounds the hollow central part 213 and is provided with four threaded holes 111 with a countersink top respectively.

The front positioning plate 22 is disposed in the recess 215 of the base disk 11 with a hollow part 222 at the center thereof for being inserted with the insert head 141. A plurality of radial grooves 223 are provided to extend from the periphery of the hollow part 222 equidistantly and two opposite ones of the radial grooves 223 constitute a space available for being passed through with the pin 142 of the insertion member 14. An elongated nest 224 is provided between every two neighboring radial grooves. In addition, the front positioning plate 22 is provided with threaded holes 221 corresponding to the threaded holes 211 of the base disk 21 and each of the threaded holes 221 has a conical top 211 extending outward from the upper end thereof.

The rear positioning lock plate 23 is disposed in the recess 217 of the base disk 21 with a hollow space 232 and threaded holes 231 corresponding to the threaded holes 211 of the base disk 21 and the threaded holes 221 of the front positioning plate 22. Further, the rear positioning lock plate 23 has an aperture 233 and a threaded hole 234 corresponding to a post 219 and a threaded hole 220 disposed at the partition between the recesses 215, 217 for locating the rear positioning lock plate 13. Due to the post 219 piercing the aperture 233 and a bolt 235 being utilized to engage with the threaded holes 234, 220 respectively, the rear positioning lock plate 13 can be located in the recess 117 securely so as to protect the base disk 11. It is noted that no specific spots are required for arranging the post 219 and the threaded hole 220 and it is all right as long as the post 219 and the threaded hole 220 are disposed at any places under a condition of the rear positioning lock plate 23 being corresponding to the base disk 21.

Thus, as the front positioning plate 22 is placed in the recess 215 and the rear positioning lock plate 23 is placed in the recess 217, the front positioning plate 22 and the rear positioning lock plate 23 can be secured to the base disk 21 by way of bolts 25 passing through and being fastened to the threaded holes 221, 211, 231. Because the four threaded holes 121 are equally spaced from each other, the front positioning plate 22 and the rear positioning lock plate 23 have two orthogonal adjustment directions respectively for different postures of the artificial model at the legs thereof. In this way, the female joining member 20 can be set up completely. Due to the threaded holes 211, 221 being provided with a countersink respectively, a flexible adjustment space is available between the front positioning plate 22 and the base disk 21 to allow the bolts 25 being capable of fastening the front positioning plate 22 and the base disk 21 firmly.

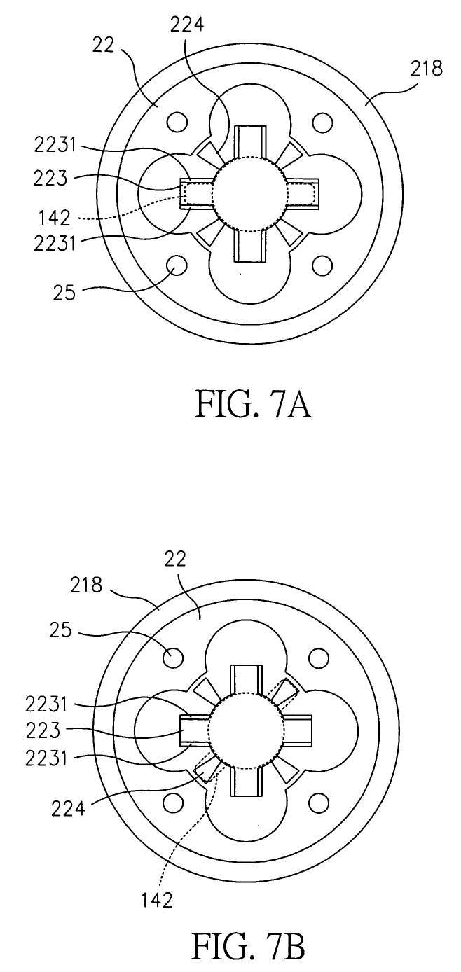

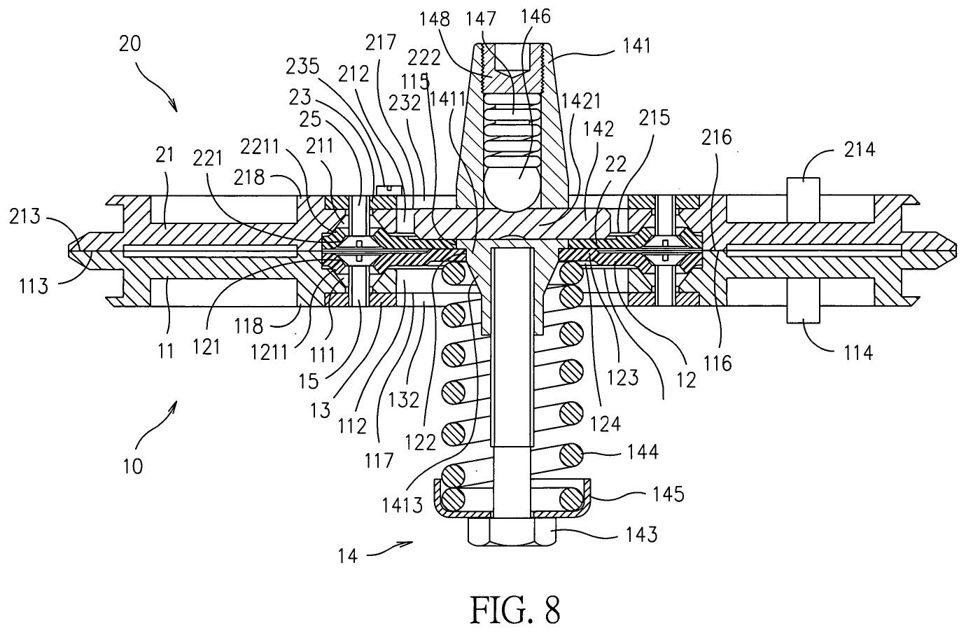

Referring to FIGS. 7A, 7B, and 8, the insertion member 14 of the male joining part 10 at the insert head 141 thereof is inserted into the hollow part 222 at the center of the front positioning plate 22 with the pin 142 passing through two opposite radial grooves 223 to allow the base disks 11, 21 being attached with the front positioning plates 12, 22 respectively. Then, the male joining member 10 is turned to allow the pin 142 rotating to the recess 224 at the lower side of the front positioning plate 22. Because the radial grooves 223 at the inner rims thereof have a chamfer respectively to facilitate the pin 142 turning into the recess 224. Due to the front positioning plate 12 with the central protrusion part 123 thereof and the elastic force of the elastic body 144 in the insertion part 14, a downward pull force can generate to exert the insert head 141 and the pin 142 to locate the pin 142 in the recess 224. In this way, the male joining part 10 and the female joining part 20 are capable of being joined to each other tightly. Further, the radial grooves 223 and the recess 224 not only can offer different rotational directions to meet the requirement for different postures of the artificial model but also a distance between neighboring radial groove 223 and the recess 224 is short so that the rotational path is reduced considerably. Hence, it can be rotated easily for saving labor hours and it is capable of avoiding the front positioning plate or the pin 142 being worn out with reduction of damage rate. When the pin 142 is located as shown in FIG. 8, the tightness of locating the pin 142 can be micro-adjusted with the adjustment bolt 143 and the male joining part 10 and the female joining part 20 can be joined together in an optimum state by way of the elastic body 144 biasing against the cap 145.

It is noted that the base disks 11, 21 have an appearance thereof corresponding to each other so that the upright rims 113, 213 result in a clearance being formed between the base disks 11, 21 to obtain contact between the base disks 11, 21 more flatly. Further, due to the male joining part 10 at the center thereof having the flange 116 corresponding to the flange 216 at the center of the female joining part 20, it is able to prevent the connection surfaces at the hips of the artificial model from being worn out caused by frictional contacts.

Referring to FIG. 8 again, after the base disks 11, 21 being exactly joined to each other, the elongated flat part 1411 can be secured to the elongated hollow part 122 with the elongated flat part 1411 at the lower end thereof providing a conical part 1413, which is not provided in the traditional artificial model, and the function of the conical part 1413 will be described in detail underneath.

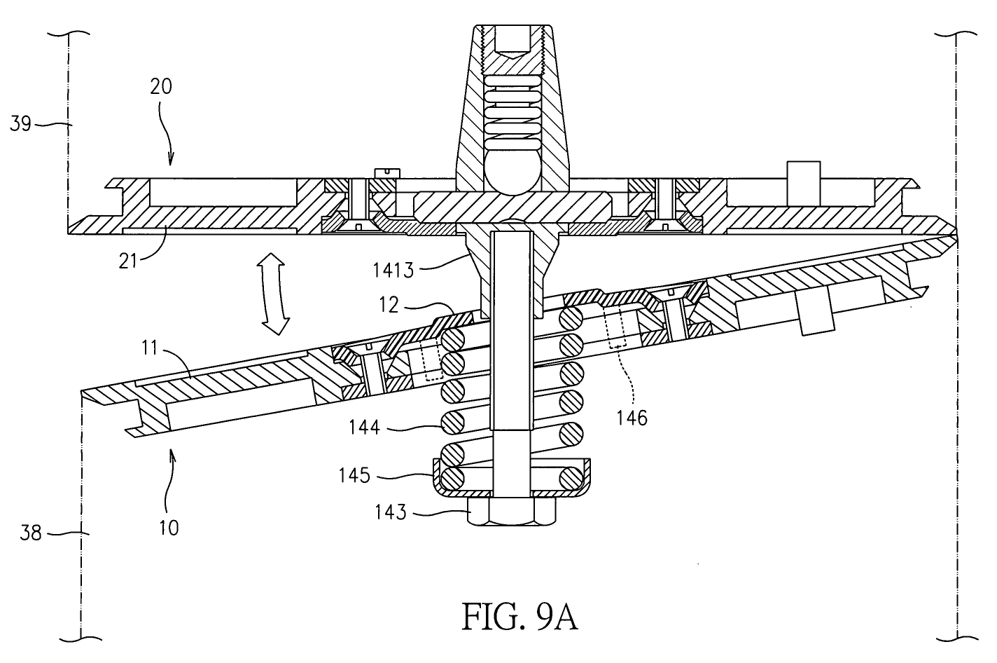

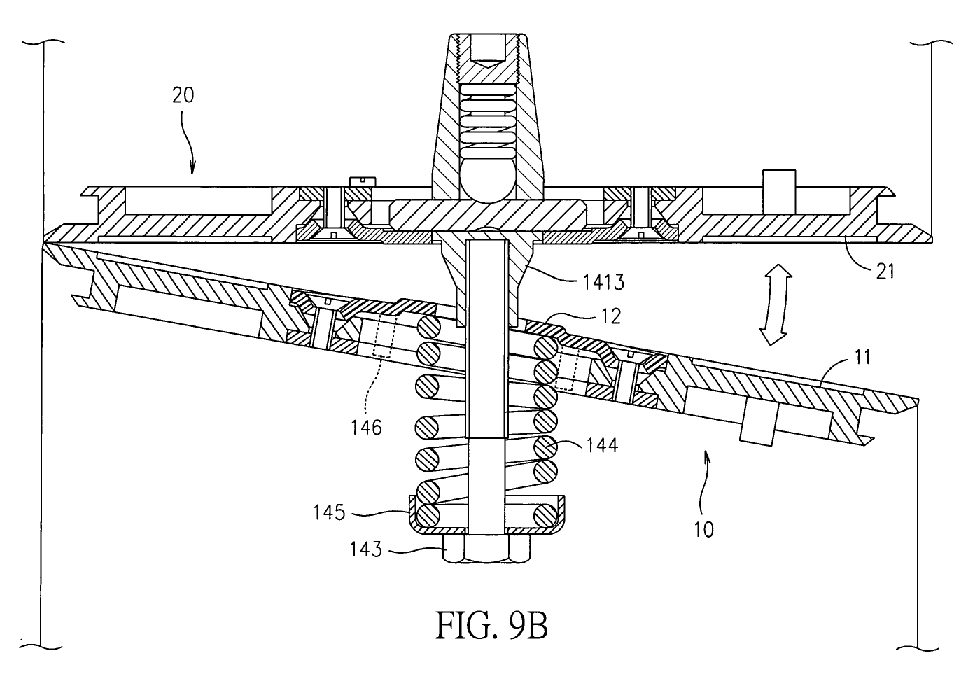

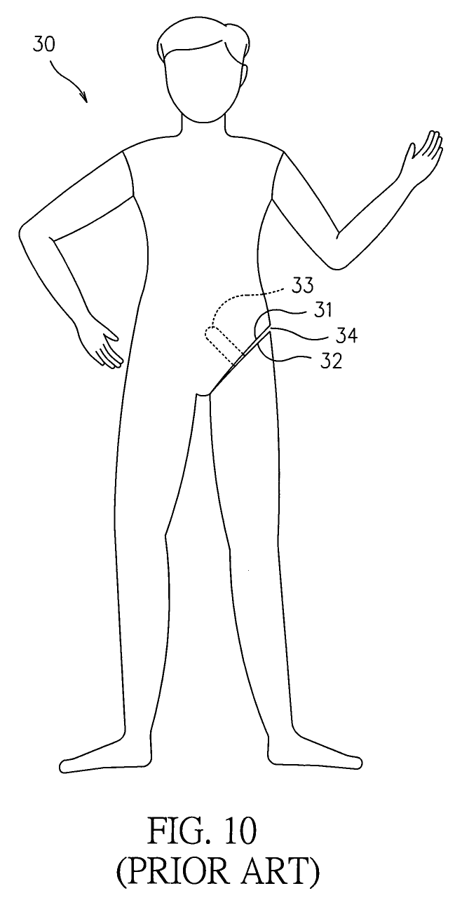

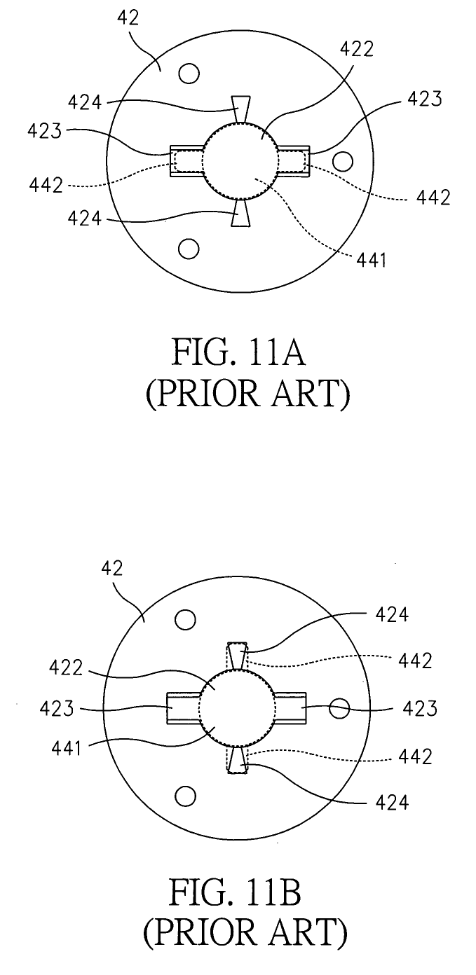

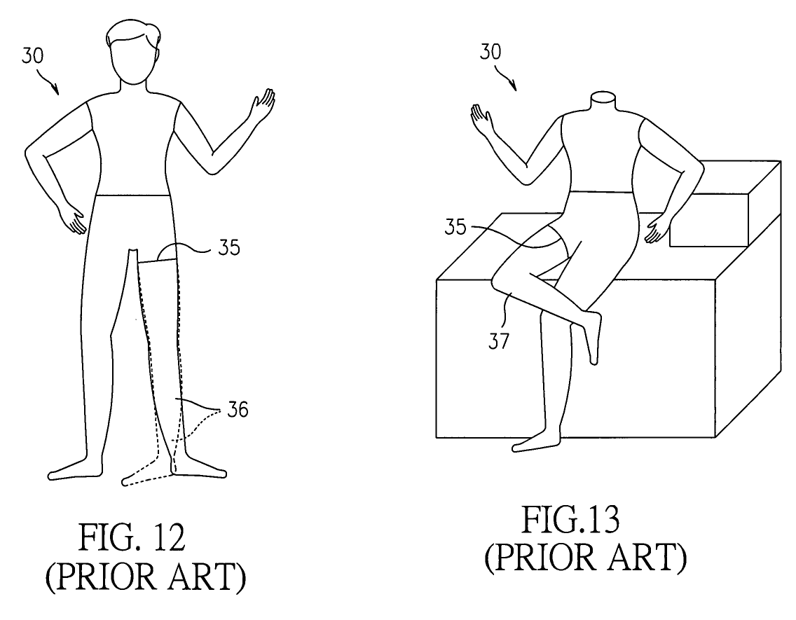

Referring to FIGS. 9A and 9B, the male joining part 10 is attached to the upper side of a thigh 38 of the artificial model 669 and the female joining part 20 is attached to the artificial model 669 at a place corresponding to the male joining part 10. The characteristic of the present invention is in that once the thigh 38 is pushed by a foreign force to actuate the base disk 11 separating from the base disk 21, the base disk 11 can comply with the taper of the conical part 1413 and restore to the original position by way of the elastic force of the elastic body 144 and the elastic body 144 is disposed to surround the adjustment bolt 143 between the front positioning plate 12 and the cap 145 such that the elastic body 144 is biased against the front positioning plate 12 and the cap 145 tightly without offsetting. Hence, it is not necessary to detach the thigh 38 before a pair of trousers can be put on to or taken off from the artificial model and the only thing has to be done is to open the thigh 38 an appropriate angle as shown in FIGS. 9A and 9B. Although FIGS. 9A and 9B illustrate the thigh 38 is opened at the right side and the left side respectively, actually, it can be opened 360 degrees surrounding the thigh 38 so that time spent for setting up the thigh 38 can be saved and damage rate can be reduced effectively. Further, the male joining part 10 and the female joining part 20 can be interchanged the positions thereof in the artificial model in practice and positions of the joining parts 10, 20 at two thighs 38 can be differently arranged as desired.

In addition, referring to FIGS. 1 to 3, the insertion member 14 at the insert head 141 thereof can be hollow with internal screw threads and the ball 146 and the elastic body 147 are placed in the hollow space such that a screw rod 148 is engaged to the internal screws to constitute a state of locating for the insertion member 14 being performed with double elastic bodies.

Moreover, the pin 142 at the middle section thereof has a recess ring 1421 to micro-adjust the screw rod 148 and the ball 146 below the screw rod 148 can press recess ring 142 so that the front positioning plate 12 can be micro-adjusted upward or downward to obtain a precise engagement.

While the invention has been described with reference to preferred embodiments thereof, it is to be understood that modifications or variations may be easily made without departing from the spirit of this invention, which is defined by the appended claims.

1. A coupling device for an artificial model, comprising
a male joining part; and
a female joining part, being joined to the male joining part tightly; wherein, the male joining part further comprises:
a first base disk with a first hollow center;
a first front positioning plate with a second hollow center, having a central protrusion part;
a rear positioning lock plate with a third hollow center;
a plurality of first bolts, fastening the base disk, the front positioning plate and the rear positioning lock plate together; and
an insertion member, passing through the base disk, the front positioning plate, the rear positioning lock plate via the hollow centers;
and the female joining part further comprises;
a second base disk;
a second front positioning plate;
a second rear positioning lock plate; and
a plurality of second bolts, fastening the second base disk, the second front positioning plate and the second rear positioning lock plate tighter;
characterized in that the first front positioning plate has a central circular protrusion; the insertion member is composed of an insert head, a pin, an adjustment bolt, an elastic body and a covering cap with the insert head having a conical shape and an elongated flat part at a bottom thereof; the pin is inserted into the insert head along a radial direction of the insert head and passing through an axis of the insert head to form a shape of cross; the second hollow center has a shape corresponding to the elongated flat part of the insert head such that the elongated flat part of the insert head can fit with the second hollow center after being inserted into the second hollow center with the adjustment bolt passing through the cap and the elastic body before engaging with the bottom of insert head; the second front positioning plate at a center thereof has a hollow part with a plurality of equidistant radial grooves and two opposite ones of the radial grooves are pierced with the pin; and a radial recess is disposed between two neighboring ones of the radial grooves respectively;
whereby, the male joining member and the female joining member can be joined to each other tightly and be inserted into each other for achieving a purpose of positioning.

2. The coupling device for an artificial model according to claim 1, wherein the insert head has a hollow part with internal screw threads and a fitting hole and another elastic body with a ball is disposed in the hollow part such that the insert head can be engaged to a screw rod and the pin has a recess and is inserted into the fitting hole with the ball being located in the recess to form a structure of at an lower section of the insert head having an elastic body in addition the original elastic body, which is disposed at an upper section of the insert head.

3. The coupling device for an artificial model according to claim 1, wherein each of the radial grooves of the second front positioning plate at an inner edge thereof has a guide chamfer.

4. The coupling device for an artificial model according to claim 1, the insert head at a lower end of the elongated flat part thereof has a conical part disposed in the elastic body and the elastic body surrounds the adjustment bolt and is disposed between the first positioning plate and the cap in a state of biasing against the first positioning plate and the cap; whereby, after the first base disk being subjected to a foreign force to separate the female joining part, the first base disk can be pushed back to original position thereof along a taper of the conical part quickly because of an elastic force of the elastic body.

5. The coupling device for an artificial model according to claim 4, wherein the first positioning plate is provided with a plurality of posts to confine the elastic body and prevent the elastic body from slip.

6. The coupling device for an artificial model according to claim 1, wherein the first base disk and the second base disk at peripheries thereof have a respective upright rim facing to each other such that a clearance between the two base disks can be formed with more smooth contact.

7. The coupling device for an artificial model according to claim 1, wherein the first base disk and the second base disk at a side thereof have a recess respectively to receive the first front positioning plate and the second front positioning plate, which are provided with a circular contour corresponding to each other, with each of the recesses having a flange to avoid hips of the artificial model at peripheries thereof being damaged due to frictional contact.

8. The coupling device for an artificial model according to claim 1, wherein the first and the second base disks have threaded holes with respect to the centers of the two base disks respectively for the base disks being attached to the hips of the artificial model.

9. The coupling device for an artificial model according to claim 8, wherein the threaded holes of the first and the second base disks are disposed equidistantly to allow the first and the second front positioning plates or the first and the second rear positioning lock plates being able to be arranged to have two adjusted cross orientations.

10. The coupling device for an artificial model according to claim 1, wherein the first and the second positioning plates at a side thereof respectively facing the threaded holes of the first and the second base disks have a jut out cone jut respectively and the threaded holes have a countersink corresponding to the jut out cone.

11. The coupling device for an artificial model according to claim 1, wherein the first front positioning plate at the rear side thereof has a locating recess for the elastic body to prevent the elastic body from slipping.

12. The coupling device for an artificial model according to claim 1, wherein the first rear positioning lock plate and the second rear positioning lock plate are provided with an aperture and a threaded hole respectively corresponding to a post and a threaded hole at the first base disk and the second base disk respectively for locating the first and the second rear positioning lock plates by way of the posts being inserted into the apertures and a bolt engaging the threaded holes respectively.

13. The coupling device for an artificial model according to claim 1, wherein the first base disk and the second base disk are provided with a recess facing the first rear positioning lock plate and the second rear positioning lock plate respectively and the rear positioning lock plate are provided with a hollow part corresponding to the posts respectively for locating the rear positioning lock plates quickly.
